(19) United States
(12) Patent Application Publication
(10) Pub. No.: US 2019/0104562 A1
(43) Pub. Date: Apr. 4, 2019

(54) APPARATUSES AND METHODS FOR HANDLING A RADIO LINK CONTROL (RLC) FAILURE

(71) Applicant: MEDIATEK INC., Hsin-Chu (TW)

(72) Inventors: Chun-Fan TSAI, Hsinchu (TW); Yuanyuan ZHANG, Beijing City (CN); Pavan Santhana Krishna NUGGEHALLI, San Jose, CA (US)

(21) Appl. No.: 16/140,781

(22) Filed: Sep. 25, 2018

Related U.S. Application Data
(60) Provisional application No. 62/565,592, filed on Sep. 29, 2017.

(51) Int. Cl. H04W 76/18; H04W 28/06; H04W 76/27; H04W 76/19

(52) U.S. Cl. CPC H04W 76/18; H04W 28/065; H04W 80/08; H04W 76/19; H04W 76/27

(57) ABSTRACT

A User Equipment (UE) including a wireless transceiver and a controller is provided. The wireless transceiver performs wireless transmission and reception to and from a primary cell (Pcell) and a secondary cell (Scell) of a service network. The controller activates duplication of Packet Data Convergence Protocol (PDCP) Packet Data Units (PDUs) for Carrier Aggregation (CA) using a plurality of Radio Link Control (RLC) entities. In response to detecting that an RLC failure of one of the RLC entities, which is not associated with the Pcell, has occurred, the controller sends a Radio Resource Control (RRC) message for reporting the RLC failure to the service network via the wireless transceiver.

### CROSS REFERENCE TO RELATED APPLICATIONS

This Application claims priority of U.S. Provisional Application No. 62/565,592, filed on Sep. 29, 2017, the entirety of which is incorporated by reference herein.

### BACKGROUND OF THE APPLICATION

### Field of the Application

The application generally relates to the handling of a Radio Link Control (RLC) failure and, more particularly, to apparatuses and methods for handling an RLC failure when Carrier Aggregation (CA) duplication is activated.

### Description of the Related Art

With the growing demand for ubiquitous computing and networking, various cellular technologies have been developed, including Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

These cellular technologies have been adopted in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, improving services, and making use of a new spectrum, and to better integrate with other open standards, as well as to support beamforming, Multiple-Input Multiple-Output (MIMO) antenna technology, and Carrier Aggregation (CA).

In case of CA, duplication to more than one logical channels is called CA duplication in which the duplicated PDCP PDUs are sent over different carriers to increase the reliability of data transmissions. In CA duplication, the duplicated PDCP PDUs are submitted to two different Radio Link Control (RLC) entities. The logical channels of these two RLC entities are associated with different carriers (i.e., different serving cells) so that the duplicated PDCP PDUs are sent over different carriers.

In a legacy 4G network, such as an LTE network, the Radio Link Failure (RLF) occurs when the maximum number of RLC retransmissions is reached, and in response to the RLF, a Radio Resource Control (RRC) re-establishment procedure may be triggered. However, the time required to complete the RRC re-establishment procedure may be quite long and may result in a service interruption.

Therefore, it is desirable to have a different design for the 5G NR network, regarding how to handle the situation where CA duplication is activated and the maximum number of RLC retransmissions associated with one of a plurality of RLC entities is reached.

### BRIEF SUMMARY OF THE APPLICATION

In order to solve the aforementioned problem, the present application proposes to handle the RLC failure by reporting the RLC failure, instead of performing the RRC re-establishment procedure, thereby reducing the interruption time caused by the RLC failure.

In one aspect of the application, a User Equipment (UE) comprising a wireless transceiver and a controller is provided. The wireless transceiver is configured to perform wireless transmission and reception to and from a primary cell (Pcell) and a secondary cell (Scell) of a service network. The controller is configured to activate duplication of Packet Data Convergence Protocol (PDCP) Packet Data Units (PDUs) for Carrier Aggregation (CA) using a plurality of Radio Link Control (RLC) entities, and in response to detecting an RLC failure of one of the RLC entities, which is not associated with the Pcell, has occurred, send a Radio Resource Control (RRC) message for reporting the RLC failure to the service network via the wireless transceiver.

In another aspect of the application, a method for handling an RLC failure, executed by a UE connected to a Pcell and an Scell of a service network, is provided. The method comprises the steps of: activating duplication of PDCP PDUs for CA using a plurality of RLC entities; and in response to detecting an RLC failure of one of the RLC entities, which is not associated with the Pcell, has occurred, sending an RRC message for reporting the RLC failure to the service network.

Other aspects and features of the present application will become apparent to those with ordinarily skill in the art upon review of the following descriptions of specific embodiments of the UEs and the methods for handling an RLC failure.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2A is a schematic diagram illustrating the CA duplication according to an embodiment of the application;

FIG. 2B is a schematic diagram illustrating the CA duplication according to another embodiment of the application;

FIG. 3 is a block diagram illustrating the UE 110 according to an embodiment of the application; and

FIGS. 4A and 4B show a message sequence chart illustrating the method for handling an RLC failure according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

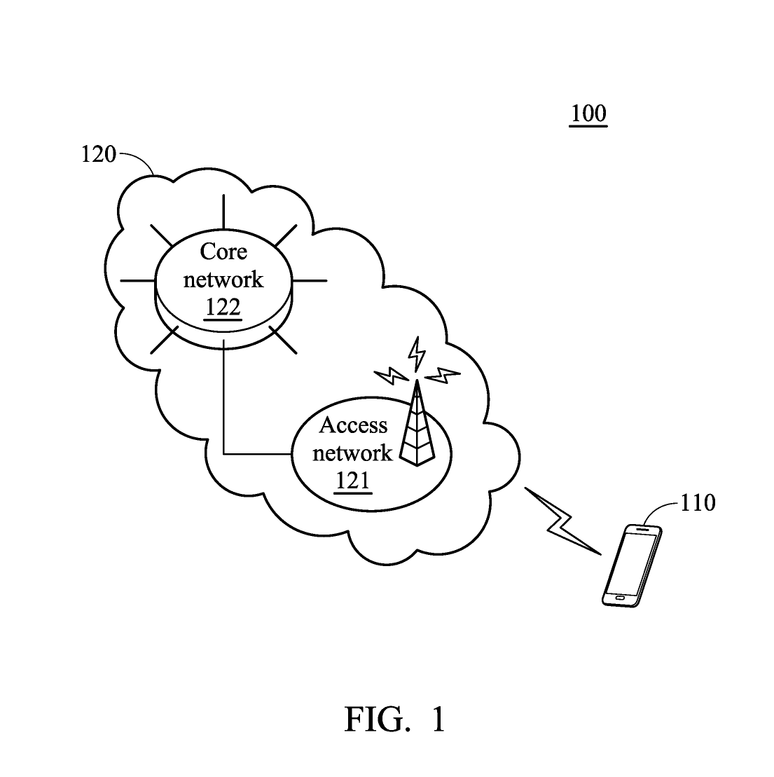

FIG. 1 is a block diagram of a wireless communication environment according to an embodiment of the application.

As shown in FIG. 1, the wireless communication environment 100 includes a User Equipment (UE) 110 and a service network 120, wherein the UE 110 may be wirelessly connected to the service network 120 for obtaining mobile services.

The UE 110 may be a feature phone, a smartphone, a panel Personal Computer (PC), a laptop computer, or any wireless communication device supporting at least the cellular technology (i.e., a legacy 4G technology (e.g., LTE, LTE-A, TD-LTE), or the 5G NR technology) utilized by the service network 120. In another embodiment, the UE 110 may support more than one cellular technology. For example, the UE may support the 5G NR technology and a legacy 4G technology, such as the LTE technology.

In addition, the UE 110 supports the function of CA duplication, in which the UE may utilize the frequency diversity of different Component Carriers (CCs) to increase the reliability of data transmissions. Specifically, when CA duplication is configured and activated, the PDCP PDUs are duplicated and submitted to different RLC entities of the UE 110, and the logical channels of these RLC entities are associated with different CCs (i.e., different serving cells) so that the duplicated PDCP PDUs are sent over different CCs.

The service network 120 includes an access network 121 and a core network 122.

The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 is a 5G NR network, and the access network 121 is a Radio Access Network (RAN) and the core network 122 is a Next Generation Core Network (NG-CN).

The RAN may include one or more cellular stations, such as gNBs, which support high frequency bands (e.g., above 24GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different CCs for providing mobile services to UEs. For example, a UE may camp on one or more cells formed by one or more gNBs or TRPs, wherein the cells which the UE is camped on may be referred to as serving cells, including a Primary cell (Pcell) and one or more Secondary cells (Scells). The UE 110 may camp on one Pcell and one or more Scells for CA duplication.

The NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

In another embodiment, the service network 120 is an LTE/LTE-A/TD-LTE network, and the access network 121 is an Evolved-Universal Terrestrial Radio Access Network (E-UTRAN) and the core network 122 is an Evolved Packet Core (EPC).

The E-UTRAN may include at least one evolved NodeB (eNB) (e.g., macro eNB, femto eNB, or pico eNB).

The EPC may include a Home Subscriber Server (HSS), Mobility Management Entity (MME), Serving Gateway (S-GW), and Packet Data Network Gateway (PDN-GW or P-GW).

It should be understood that the 5G NR network 120 depicted in FIG. 1 is for illustrative purposes only and is not intended to limit the scope of the application. For example, the application could be applied to other cellular technologies, such as a future enhancement of the 5G NR technology.

It should be understood that the wireless communication environment 100 described in the embodiment of FIG. 1 are for illustrative purposes only and are not intended to limit the scope of the application. For example, the wireless communication environment 100 may further include both a 5G NR network and a legacy 4G network, and the UE 110 may be wirelessly connected to both the 5G NR network and the legacy 4G network for CA duplication. That is, the UE 110 may have dual connectivities with the 5G NR network and the legacy 4G network simultaneously. This scenario is called Evolved-Universal Terrestrial Radio Access(E-UTRA)-NR Dual Connectivity (EN-DC), when the legacy 4G network refers to an LTE network.

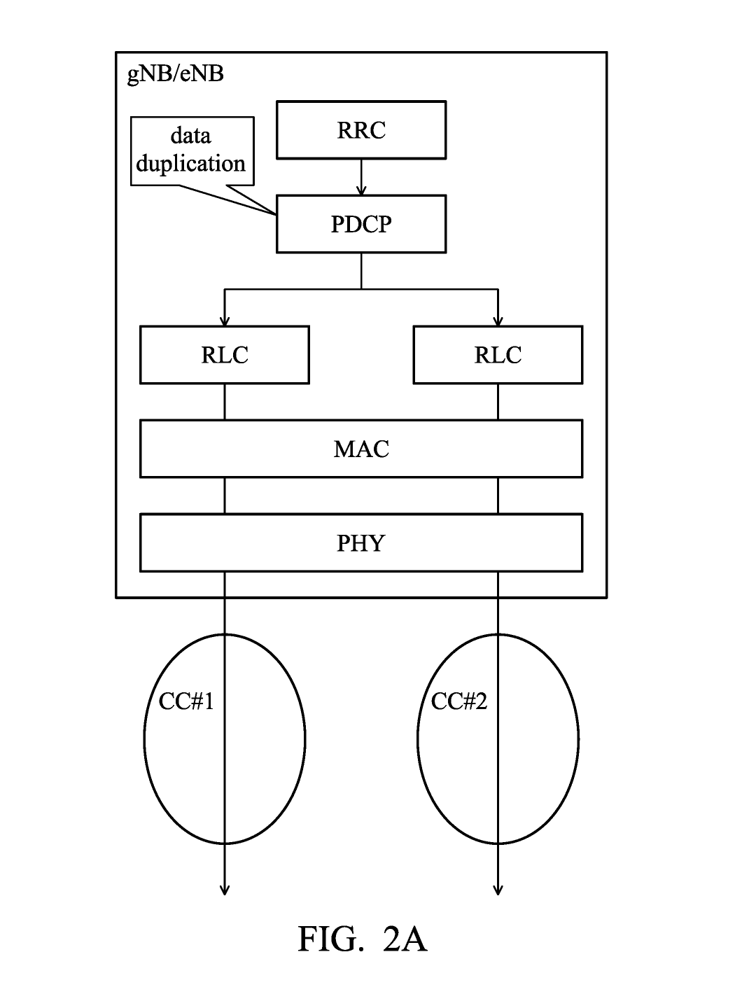

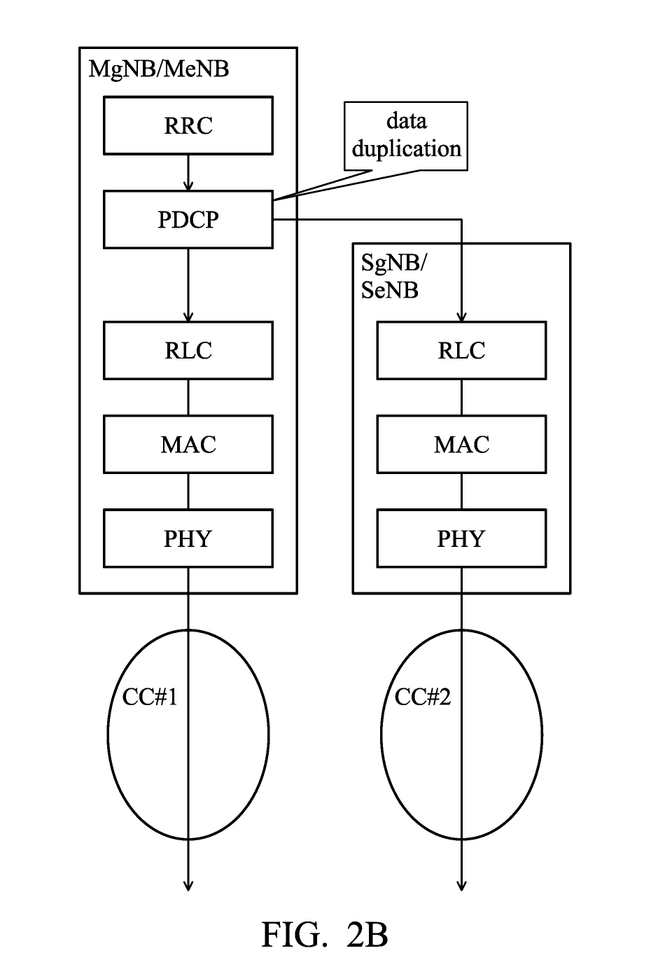

FIG. 2A is a schematic diagram illustrating the CA duplication according to an embodiment of the application.

In this embodiment, the UE 110 is connected to two cells formed by a gNB/eNB of the service network 120, and through the cells, the UE 110 receives duplicated PDCP PDUs from the service network 120.

FIG. 2B is a schematic diagram illustrating the CA duplication according to another embodiment of the application.

In this embodiment, the UE 110 is connected to one cell formed by a Master gNB (MgNB) or Master eNB (MeNB) and one cell formed by a Secondary gNB (SgNB) or a Secondary eNB (SeNB), and through the cells, the UE 110 receives duplicated PDCP PDUs from the service network 120.

The MgNB/MeNB and the SgNB/SeNB may both belong to a 5G NR network or a legacy 4G network. Alternatively, the MgNB/MeNB and the SgNB/SeNB may belong to a 5G NR network and a legacy 4G network (e.g., an LTE network), respectively.

Please note that, as shown in FIGS. 2A and 2B, the radio protocol architecture for CA duplication places multiple RLC entities below a single PDCP layer. The PDUs processed and duplicated in the PDCP layer are transferred to each RLC entity and logical channel, and then transmitted via the associated CCs. The PDCP layer on the receiving side (i.e., the UE 110) may process the PDCP PDUs that arrive earlier and discard the delayed ones as duplicates. Transmitting the same data over multiple radio links makes for high-reliability communications, due to that the data may be delivered over a good radio link when the radio quality of the other radio link deteriorates.

It should be understood that the radio protocol architecture for CA duplication in the UE 110 is similar to the radio protocol architecture as shown in FIG. 2A, and the detailed description thereof is omitted herein for brevity.

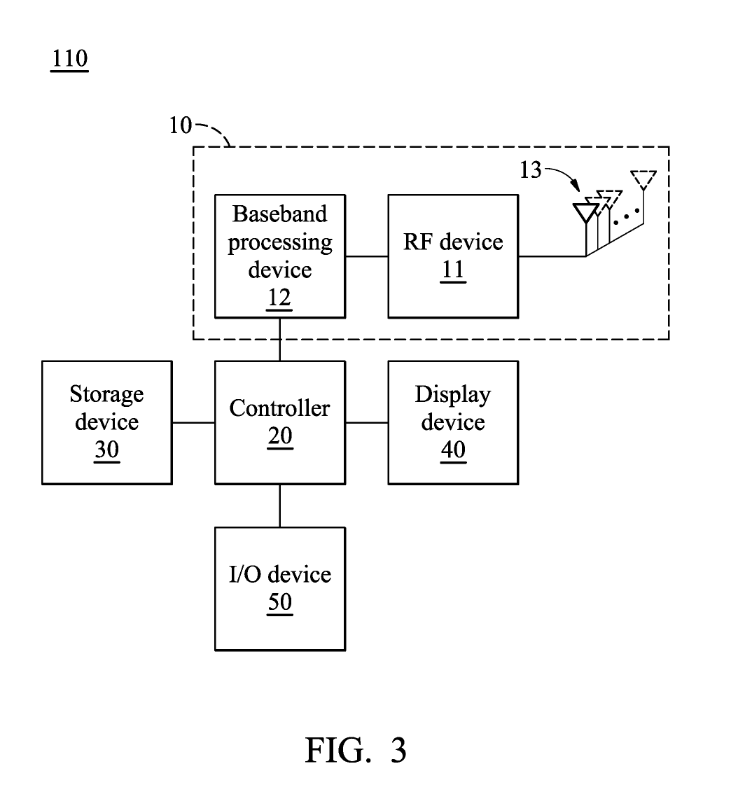

FIG. 3 is a block diagram illustrating the UE 110 according to an embodiment of the application.

As shown in FIG. 3, the UE 110 includes a wireless transceiver 10, a controller 20, a storage device 30, a display device 40, and an Input/Output (I/O) device 50.

The wireless transceiver 10 is configured to perform wireless transmission and reception to and from the cells formed by a gNB/TRP of the RAN 121. Specifically, the wireless transceiver 10 includes a Radio Frequency (RF) device 11, a baseband processing device 12, and antenna(s) 13, wherein the antenna(s) 13 may include one or more antennas for beamforming. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may comprise a mixer to multiply the baseband signals with a carrier oscillated in the radio frequency of the supported cellular technologies, wherein the radio frequency may be any radio frequency (e.g., 30 GHz˜300 GHz for mmWave) utilized in the 5G NR technology, or may be 900 MHz, 2100 MHz, or 2.6 GHz utilized in LTE/LTE-A/TD-LTE technology, or another radio frequency, depending on the cellular technology in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communications with the cells formed by cellular station of the access network 121, storing and retrieving data (e.g., program code) to and from the storage device 30, sending a series of frame data (e.g. representing text messages, graphics, images, etc.) to the display device 40, and receiving signals from the I/O device 50.

In particular, the controller 20 coordinates the aforementioned operations of the wireless transceiver 10, the storage device 30, the display device 40, and the I/O device 50 for performing the method for handling an RLF failure.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., measurement results), instructions, and/or program code of applications, communication protocols, and/or the method for handling an RLC failure.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 3 are for illustrative purposes only and are not intended to limit the scope of the application. For example, the UE 110 may include more components, such as a power supply, and/or a Global Positioning System (GPS) device, wherein the power supply may be a mobile/replaceable battery providing power to all the other components of the UE 110, and the GPS device may provide the location information of the UE 110 for use of some location-based services or applications. Alternatively, the UE 110 may include fewer components. For example, the UE 110 may not include the display device 40 and/or the I/O device 50.

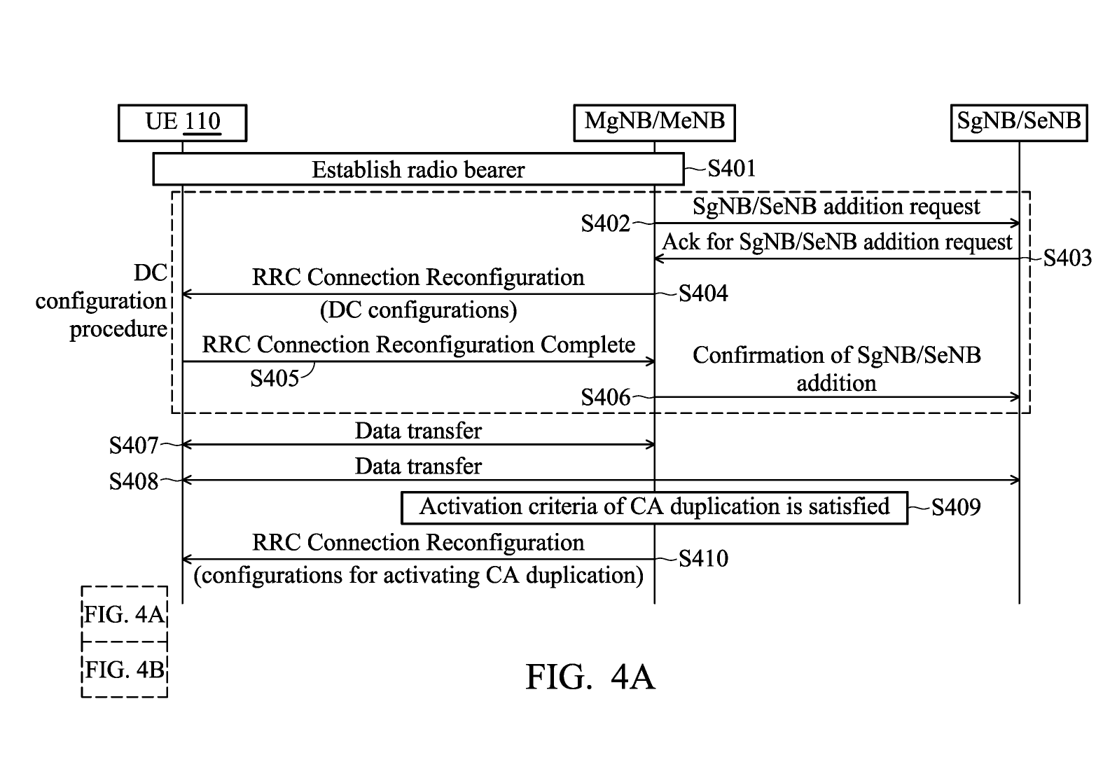

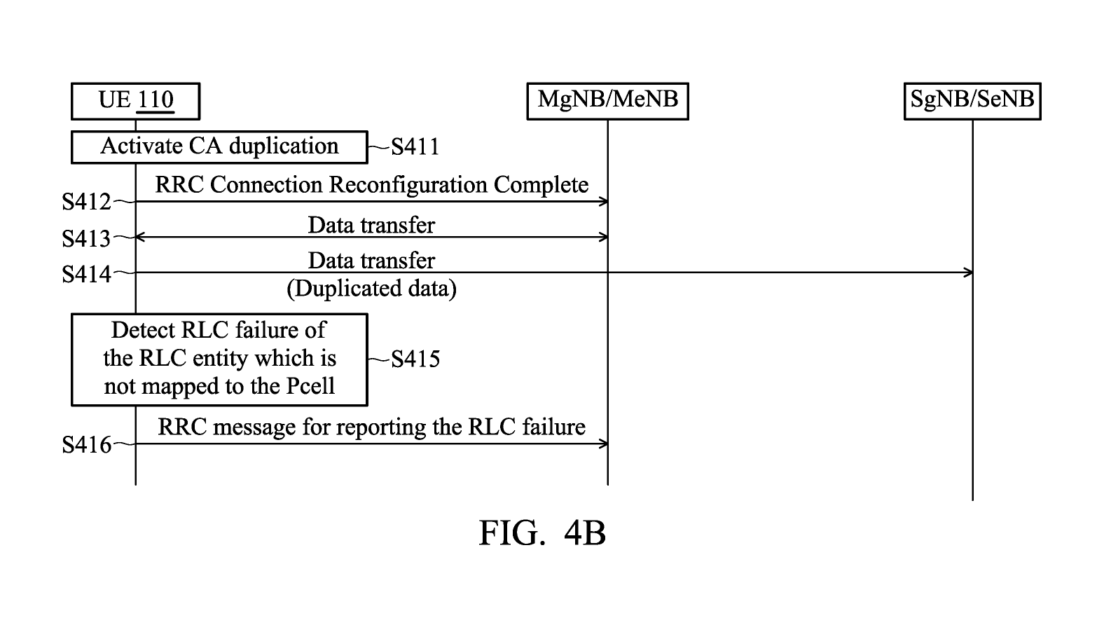

FIGS. 4A and 4B show a message sequence chart illustrating the method for handling an RLC failure according to an embodiment of the application.

In this embodiment, the method for handling an RLC failure is executed by the UE 110 and the UE 110 is connected to a Pcell formed by an MgNB/MeNB and an Scell formed by an SgNB/SeNB, wherein the MgNB/MeNB and the SgNB/SeNB may be both belong to a 5G NR network or a legacy 4G network, or may belong to a 5G NR network and a legacy 4G network, respectively (in the EN-DC scenario).

To begin with, the UE 110 performs an establishment of a radio bearer with the MgNB/MeNB (step S401).

Specifically, the radio bearer establishment may be achieved by an RRC connection establishment procedure in which the UE 110 may send an RRC Connection Request message to the MgNB/MeNB, receive an RRC Connection Setup message including the radio bearer configurations from the MgNB/MeNB, and reply to the MgNB/MeNB with an RRC Connection Setup Complete message.

Next, the MgNB/MeNB sends a request for SgNB/SeNB addition to the SgNB/SeNB (step S402), and receives an acknowledgement of the request from the SgNB/SeNB (step S403).

When receiving the acknowledgement, the MgNB/MeNB sends an RRC Connection Reconfiguration message including the DC configurations to the UE 110 (step S404), and receives an RRC Connection Reconfiguration Complete message from the UE 110 (step S405).

When receiving the RRC Connection Reconfiguration Complete message, the MgNB/MeNB sends a confirmation of the SgNB/SeNB addition to the SgNB/SeNB to complete the DC configuration procedure (step S406).

After the DC configuration procedure, the UE 110 may exchange data with the MgNB/MeNB (step S407), and simultaneously exchange data with the SgNB/SeNB (step S408).

Subsequently, when the activation criteria of CA duplication is satisfied (step S409), the MgNB/MeNB sends an RRC Connection Reconfiguration message including the configurations for activating CA duplication to the UE 110 (step S410).

When receiving the RRC Connection Reconfiguration message, the UE 110 activates duplication of PDCP PDUs for CA using a plurality of RLC entities according to the configurations for activating CA duplication in the RRC Connection Reconfiguration message (step S411).

After that, the UE 110 replies to the MgNB/MeNB with an RRC Connection Reconfiguration Complete message (step S412).

Specifically, after CA duplication has been activated, the UE 110 will have two RLC entities that are associated with different serving cells. For example, one RLC entity is associated with the Pcell formed by the MgNB/MeNB, and another RLC entity is only associated with the Scell formed by the SgNB/SeNB.

With the activation of CA duplication, the UE 110 may exchange data with the MgNB/MeNB (step S413), and simultaneously, the same data is duplicated and exchanged between the UE 110 and the SgNB/SeNB (step S414).

Subsequently, the UE 110 detects that an RLC failure of the RLC entity which is not associated with the Pcell (e.g., the serving cell formed by the MgNB/MeNB) has occurred (step S415). In other words, the RLC entity is only associated with the Scell (e.g., the serving cell formed by the SgNB/SeNB). Specifically, the RLC failure refers to or indicates that the maximum number of retransmissions related to the RLC entity which is not associated with the Pcell has been reached.

In response to detecting the RLC failure, the UE 110 sends an RRC message for reporting the RLC failure to the MgNB/MeNB, without performing an RRC re-establishment procedure (step S416), and the method ends.

Specifically, the RRC message may be sent via the Signaling Radio Bearer (SRB) 3 or the SRB1. For example, in the EN-DC scenario, the RRC message may be sent via the SRB3, or may be sent via the SRB1 using a generic container message.

In one embodiment, the RRC message may be the same RRC message used for Secondary Cell Group (SCG) failure report. That is, the RRC message may be an SCG Failure Information message.

In another embodiment, the RRC message may a new message dedicated for RLC failure report. For example, the RRC message may be an Scell Failure Information message or an RLC Failure Report message.

Specifically, the RRC message may include the logical channel identity of the RLC entity having the RLC failure; or it may include an indication of that the RRC message is used for reporting the RLC failure; or it may include the measurement results of the Scell which the RLC entity having the RLC failure is associated with; or it may include the measurement results of the intra-frequency neighbor cells of the Scell which the RLC entity having the RLC failure is associated with; or it may include any combination thereof.

Although not shown, subsequent to step S416, the UE 110 may receive further configurations of CA duplication from the MgNB/MeNB. For example, further configurations may refer to deactivation of CA duplication, or addition of another SgNB/SeNB.

Alternatively, subsequent to step S416, the UE 110 may further deactivate CA duplication locally (i.e., deactivating the duplication of PDCP PDUs) in response to detecting the RLC failure.

Alternatively, subsequent to step S416, the UE 110 may further stop sending the PDCP PDUs to the RLC entity having the RLC failure in response to detecting the RLC failure.

Alternatively, subsequent to step S416, the UE 110 may further re-establish the RLC entity having the RLC failure in response to detecting the RLC failure.

Alternatively, subsequent to step S416, the UE 110 may further establish a new RLC entity to replace the RLC entity having the RLC failure in response to detecting the RLC failure.

It should be understood that the message sequence chart described in the embodiment of FIGS. 4A-4B is for illustrative purposes only and is not intended to limit the scope of the application. For example, the Pcell and the Scell to which the UE 110 is connected may be both formed by the same gNB/eNB, and the DC configuration procedure may be omitted.

In view of the forgoing embodiments, it will be appreciated that the present application proposes to handle the RLC failure by reporting the RLC failure, instead of performing the RRC re-establishment procedure. Moreover, the present application proposes specific embodiments of the RRC message used for reporting the RLC failure, as well as the UE behaviors subsequent to reporting the RLC failure. Advantageously, the interruption time caused by the RLC failure may be significantly reduced, and indeterminate behaviors of the UE may be avoided.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A User Equipment (UE), comprising:
a wireless transceiver, configured to perform wireless transmission and reception to and from a primary cell (Pcell) and a secondary cell (Scell) of a service network; and
a controller, configured to activate duplication of Packet Data Convergence Protocol (PDCP) Packet Data Units (PDUs) for Carrier Aggregation (CA) using a plurality of Radio Link Control (RLC) entities, and in response to detecting that an RLC failure of one of the RLC entities, which is not associated with the Pcell, has occurred, send a Radio Resource Control (RRC) message for reporting the RLC failure to the service network via the wireless transceiver.

2. The UE of claim 1, wherein the RLC failure indicates that a maximum number of retransmissions related to the RLC entity which is not associated with the Pcell has been reached.

3. The UE of claim 1, wherein the RRC message comprises a logical channel identity of the RLC entity having the RLC failure.

4. The UE of claim 1, wherein the RRC message comprises an indication of that the RRC message is used for reporting the RLC failure of the RLC entity which is not associated with the Pcell.

5. The UE of claim 1, wherein the RLC entity having the RLC failure is associated with the Scell, and the RRC message comprises measurement results of the Scell.

6. The UE of claim 1, wherein the RLC entity having the RLC failure is associated with the Scell, and the RRC message comprises measurement results of one or more intra-frequency neighbor cells of the Scell.

7. The UE of claim 1, wherein the RRC message is a Secondary Cell Group (SCG) Failure Information message for SCG failure report.

8. The UE of claim 1, wherein the RRC message is sent via a Signaling Radio Bearer (SRB) 3 or an SRB1.

9. The UE of claim 1, wherein the controller is further configured to perform one of the following actions in response to detecting the RLC failure:
deactivating duplication of the PDCP PDUs for CA;
stopping sending the PDCP PDUs to the RLC entity having the RLC failure;
re-establishing the RLC entity having the RLC failure; and
establishing a new RLC entity to replace the RLC entity having the RLC failure.

10. A method for handling an RLC failure, executed by a UE connected to a Pcell and an Scell of a service network, comprising:
activating duplication of PDCP PDUs for CA using a plurality of RLC entities; and
in response to detecting an RLC failure of one of the RLC entities, which is not associated with the Pcell, has occurred, sending an RRC message for reporting the RLC failure to the service network.

11. The method of claim 10, wherein the RLC failure indicates that a maximum number of retransmissions related to the RLC entity which is not associated with the Pcell has been reached.

12. The method of claim 10, wherein the RRC message comprises a logical channel identity of the RLC entity having the RLC failure.

13. The method of claim 10, wherein the RRC message comprises an indication of that the RRC message is used for reporting the RLC failure of the RLC entity which is not associated with the Pcell.

14. The method of claim 10, wherein the RLC entity having the RLC failure is associated with the Scell, and the RRC message comprises measurement results of the Scell.

15. The method of claim 10, wherein the RLC entity having the RLC failure is associated with the Scell, and the RRC message comprises measurement results of one or more intra-frequency neighbor cells of the Scell.

16. The method of claim 10, wherein the RRC message is an SCG Failure Information message for SCG failure report.

17. The method of claim 10, wherein the RRC message is sent via an SRB3 or an SRB1.

18. The method of claim 10, further comprising performing one of the following actions in response to detecting the RLC failure:
deactivating duplication of the PDCP PDUs for CA;
stopping sending the PDCP PDUs to the RLC entity having the RLC failure;
re-establishing the RLC entity having the RLC failure; and
establishing a new RLC entity to replace the RLC entity having the RLC failure.
